(19) United States
(12) Patent Application Publication
(10) Pub. No.: US 2005/0050945 A1
(43) Pub. Date: Mar. 10, 2005

(54) Device for determining information regarding the position of the center of gravity of a person using a piece of sports equipment

(76) Inventor: Josef Hrovath, Riegersdorf (AT)

Correspondence Address: KIRKPATRICK & LOCKHART NICHOLSON GRAHAM LLP, 535 SMITHFIELD STREET, PITTSBURGH, PA, 15222, US

(21) Appl. No.: 10/916,947

(22) Filed: Aug. 12, 2004

(30) Foreign Application Priority Data
Aug. 22, 2003 (AT) A1329/2003

(51) Int. Cl. G01M 1/12; B62B 17/00

(52) U.S. Cl. 73/65.09; 73/65.01; 280/816

(57) ABSTRACT

The invention pertains to a device placed on a piece of sports equipment such as a ski, snowboard, grass ski, surfboard, windsurfer, etc., for determining information regarding the position of the center of gravity of a person using the piece of sports equipment. The device is characterized in that sensors that measure the instantaneous forces are placed between the user's feet and the piece of sports equipment, and that the position of the center of gravity is determined from the measurement results by an evaluation unit and is displayed audibly or visually in a suitable fashion.

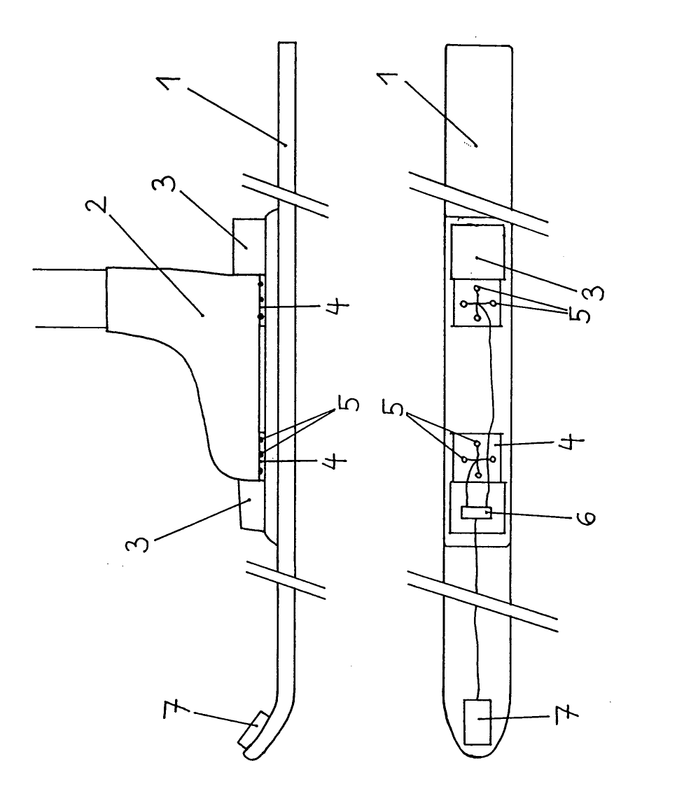

The invention pertains to a device placed on a piece of sports equipment such as a ski, snowboard, grass ski, surfboard, windsurfer, etc., for determining information regarding the position of the center of gravity of a person using the piece of sports equipment.

In many kinds of sports, especially skiing and snowboarding, it is important that the user maintain his center of gravity in a very specific relationship to the surface area of the piece of sports equipment, specifically, that the center of gravity is located above a certain region of this surface area of the piece of sports equipment. In the present description, surface area is always understood to mean an essentially flat surface area, even though both skis and snowboards exhibit an intrinsic curvature when in the unladen resting state. If we disregard the curved tip region, this curvature can be replaced by a flat middle region with sufficient accuracy for the purposes of the present application, whereby the way in which the mean value is determined has no appreciable influence on the result, and thus on the invention.

Now, in order to be helpful especially to people who are just beginning to learn the sport, it would be useful to be able to provide them with ongoing information regarding whether or not they have positioned their center of gravity correctly with reference to the piece of equipment. All that is available at the present time for doing that is shouts from trainers and instructors who for their part have to rely on rough estimates, which is inevitably unreliable and inaccurate with increasing distance, poor weather and from various perspectives.

The invention is aimed at creating a device by means of which the cited problems can be eliminated and through which it is made possible to give people using such a piece of sports equipment reliable information regarding the position of their center of gravity.

According to the invention, these goals are attained in that sensors that measure the instantaneous forces are placed between the user's feet and the piece of sports equipment, and that the position of the center of gravity is determined from the measurement results by an evaluation unit and is displayed audibly or visually in a suitable fashion.

In practice, on most pieces of sports equipment these measurement sensors are provided either between the piece of sports equipment and the binding or between the binding and the boot. The sensors preferably work in an electrocapacitive way, very preferably involving piezo elements. The calculation of the measurement results and thus the determination of the position of the center of gravity can be carried out easily by a person skilled in the art who is familiar with the invention and the selected sensors, and does not require further description here.

The readout can take place, for example, by means of a display in the front part of the piece of sports equipment where it can be easily glimpsed by the user, whereby in particular, displays on films or something similar that can easily be adapted to the surface shape of the piece of sports equipment are preferably used. Other possibilities consist in indicating whether the center of gravity is too far forward or too far back relative to the correct position by means of audible signals, and the region where the correct position is located is indicated by silence. Of course, other audible measures are conceivable as well.

Particularly when the measured values are recorded between the binding and the boot, it is possible to display the measurement results on the handle of the pole, whereby the data transmission can take place either via wire or wirelessly; here, all of the display options that are presently being used in civilian life as well as in the military are conceivable, even including incorporation into the snow goggles.

The invention is described below in more detail with the aid of the FIGURE. A ski boot 2 rests in the binding 3 of a ski 1. Placed on the support surfaces 4 of the binding plate that comes in direct contact with the underside of the ski boot 2 are pressure sensors 5 that measure the forces transmitted by the ski boot 2 to the ski 1. Because the load relationships on the support surfaces 4 are constantly and continuously changing in the case of the example being described, piezoelectric pressure transducers are especially well-suited for this purpose. The arrangement and number of pressure sensors is not limited by the described example. Specifically in the case of skiing, however, four pressure sensors in a cruciform arrangement can provide all of the information needed by the skier. First, the values of the four pressure sensors 5 placed on one support surface can be determined in order to avoid false information due to unevenness on the bottom of the ski boot, second, through separate evaluation of all four sensors, information can also be obtained regarding lateral load distributions, i.e., that are taking place perpendicular to the ski, brought about by tilted positions on the part of the skier. The signals from the sensors are transmitted via wires in or on the ski or the binding to an evaluation unit 6 that is preferably placed in or on the binding 3. This unit then generates signals or information that is shown by a display 7, which is in communication with the evaluation unit 6 and which in the example shown is placed at the front end of the ski 1. As has already been mentioned above, the communication between the evaluation unit 6 and the display and the pressure sensors 5 can also take place via radio. Accordingly, the display 7 can also be attached to ski poles, gloves, or ski goggles. In place of the visual rendering of information, transmitted audible rendering would also be possible, e.g., by means of earphones.

Of course, taking the relevant boundary conditions into account, the principles of the invention are also applicable to other kinds of sports that are practiced on sports equipment; for example, by means of a flat mat provided with several sensors that is mounted on a surfboard or sailboard, it is possible to indicate the instantaneous position of the user's center of gravity and thus get him to easily recognize and automatically assume the correct position. When a windsurfer is being used, it is also possible for the force acting on the mast or the holding forces of the hands to be included in the calculation.

1. Device placed on a piece of sports equipment such as a ski, snowboard, grass ski, surfboard, windsurfer, etc., for determining information regarding the position of the center of gravity of a person using the piece of sports equipment, characterized in that sensors (5) that measure the instantaneous forces are placed between the user's feet and the piece of sports equipment (1), and that the position of the center of gravity is determined from the measurement results by means of an evaluation unit (6) and is displayed audibly or visually in a suitable fashion by means of a display unit (7).

2. Device according to claim 1, characterized in that the sensors (5) are placed on a piece of sports equipment (1).

3. Device according to claim 2 on a piece of sports equipment (1) with a binding (3), characterized in that the sensors (5) are placed on the binding (3).

4. Device according to one of the preceding claims, characterized in that the evaluation unit (6) is mounted on the piece of sports equipment (1) or is integrated in the piece of sports equipment (1).

5. Device according to one of the preceding claims, characterized in that the display unit (6) [sic] is mounted on the piece of sports equipment (1) or is integrated in the piece of sports equipment (1).

6. Device according to one of the preceding claims on a ski, characterized in that the display unit (6) [sic] is mounted on a pole.

7. Device according to one of the preceding claims, characterized in that the display unit (6) [sic] is placed on the user's helmet or goggles.

8. Device according to one of the preceding claims, characterized in that the sensors (5) work on a piezoelectric basis.

9. Device according to one of the preceding claims, characterized in that the sensors (5) work on the basis of strain gauges.
